(19) United States
(12) Patent Application Publication
(10) Pub. No.: US 2005/0119980 A1
(43) Pub. Date: Jun. 2, 2005

(54) Electronic negotiation systems

(75) Inventors: Itai Kohavi, Hod Hasharon (IL); Daniel Aharon, Holon (IL)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Neat Group Corporation, Herzliya (IL)

(21) Appl. No.: 11/030,750

(22) Filed: Dec. 17, 2004

Related U.S. Application Data
(62) Division of application No. 09/607,138, filed on Jun. 29, 2000.

(51) Int. Cl. G06F 17/60

(52) U.S. Cl. 705/80

(57) ABSTRACT

A system and method has been shown in the above embodiments for the effective implementation of electronic negotiating sessions. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, specific computing hardware, specific types of suppliers or specific negotiating rules or applications.

### CROSS-REFERENCE TO RELATED APPLICATIONS

The present is a divisional application of co-pending U.S. patent application Ser. No. 09/607,138 filed on Jun. 29, 2000 the disclosure of which is incorporated by reference herein.

### BACKGROUND OF THE INVENTION

1. Field of Invention

The present invention relates generally to the field of e-commerce. More specifically, the present invention is related to a system and method for managing an electronic negotiation of offered products such as travel related services.

2. Discussion of Prior Art

The art of negotiating is revered within the business world as essential to maximizing sales and profits. Finely tuned negotiation skills can mean the difference between a successful acquisition at a desired or lower price and a failed attempt or acquisition at too high a cost. A negotiation session consists of a point-counterpoint structure where both sides make offers and counter-offers until both sides are in agreement to exchange tangible assets as represented by their offers. In an unsuccessful negotiation session, the parties may agree to quit the negotiation for failure to conclude the negotiation session in a desired time frame or with desired results.

In the ever-expanding world of e-commerce, a multitude of vendors, auctioneers, clearing houses, virtual catalogs, third party agents, and other Internet entities provide one or more e-commerce solutions to pass tangible assets between themselves and one or more purchasers. In most cases, the sources of goods offer set non-negotiable prices. An on-line shopper peruses the vendors' electronic web pages, selects one or more products, and enters into a financial transaction for purchase. In some embodiments, such as on-line auctions, a potential purchaser may make one or more offers which may be public (e.g., eBay®) or sealed private bids. In the instance of third party agents, an electronic middleman may take the parameters of your request and seek potential suitors matching or closely matching your requirements out onto the Web. In each of these cases, however, the user is limited to the terms as offered by the seller, without the means to modify the content, terms or other associated parameters interactively. For instance, in the case of an Internet auction, a user wishing to purchase 3 similar items may have to participate in multiple auctions with multiple sellers to obtain all 3 items. Each auction exposes the purchaser to different price and content variables. A better solution would be to enable the potential purchaser to make one or more offers to a single entity to thereby gain an economy of scale, i.e., volume discount. The offers should include the ability to vary the content, price or other negotiable details of the possible transaction. In addition, the system should be available to both businesses and consumers, combining the elements common to either entity, while retaining the unique dynamics of each type of transaction (e.g., an e-contract between businesses). The offerer should also be able to dynamically modify the limitations which are negotiable, such as price, the number of offers, incremental changes to price, time or other structural or functional aspects of the offers, etc.

The prior art has tried, but failed, to create an Internet/WWW negotiation session arbitrated by an automatic mechanism where both the content and terms (including price) are interactively negotiable. In addition, the prior art has failed to include an automatic mechanism available to both consumers and businesses.

The following prior art offers some suggestions of methods and systems for performing electronic negotiations.

The patent to Micali (U.S. Pat. No. 5,615,269) provides for a system for Ideal Electronic Negotiations. Disclosed is an electronic based transaction method that enables participants (buyers and sellers) in a negotiation to agree on a common price for a given transaction. Both the buyer and the seller set reservation prices and an electronic trustee determines if a deal is possible. Additionally, a mechanism is described for conducting blind negotiations.

The patent to Silverman et al. (U.S. Pat. No. 5,924,082), assigned to Geneva Branch of Reuters Transaction Services Limited, provides for a Negotiated Matching System. Disclosed is a negotiated matching system which provides for the following functions: (i) Matching potential counterparties who are acceptable to each other based on trading and ranking information; (ii) and allowing the counterparties to negotiate and finalize the terms of a transaction.

The patent to Solomon (U.S. Pat. No. 6,035,288), assigned to Cendant Publishing, Inc., provides for an Interactive Computer-Implemented System and Method for Negotiating Sale of Goods and/or Services. Of interest is a dynamic and interactive computer-implemented system which is capable of selling, through a distributed network such as the Internet, goods and/or services that have negotiable prices. A customer or user of the system engages in dialog with a simulated merchant having a predefined algorithm. The simulated merchant responds to the customer's input data and agrees to a particular price according to the algorithm.

The non-patent literature entitled “Inspire” describes a web-based negotiation support system.

The non-patent literature entitled “Automated Negotiations” describes negotiation processes in electronic commerce. This reference includes intelligent software agents that negotiate with each other in an environment governed by predefined rules.

Whatever the precise merits, features and advantages of the above cited references, none of them achieves or fulfills the purposes of the present invention. These and other objects are achieved by the detailed description that follows.

### SUMMARY OF THE INVENTION

The present invention includes a system and method for automatically operating an e-commerce negotiation between either a business and a consumer (B2C) or two or more businesses (B2B).

The B2C negotiation sub-product is destined for suppliers who wish to extend their web presence by giving their customers the unique ability to negotiate content and terms (including prices) of travel products sold in their website. The negotiation itself is a series of offers from both sides for the various terms pertaining to a product to be purchased. Sophisticated algorithms enable negotiation of additional terms such as payment form, delivery time, delivery methods and can be extended to almost any article that is used in sale negotiations today in deals between suppliers and consumers.

The negotiation from the supplier's side is performed automatically by the present invention B2C software, B2C comes with a set of basic rules that enable it to carry the negotiation of a product's sale independently, yet wisely. Nevertheless, the present invention can have B2C act in different ways, by defining a set of directive rules that relate to different negotiation situations.

Each negotiation session (N-Session) starts with a list of terms that are pre-defined in a database and include things such as: List Price, Payment Methods and Availability. Also, stated at the beginning of each N-Session are the terms that are open for discussion.

The consumer is free to choose any of the purchase terms that are open for discussion and then negotiate the specifics of that term. The consumer is free to quit the negotiation at any time. Many times, consumers must enter several details on the product they're interested in, before starting negotiation (e.g., “I need a two days vacation in England on the first week of February”). Based on the supplier's decisions and specific tailoring, various behaviors can be presented to the consumer. For example, on one hand, consumers might be able to re-discuss terms that were already agreed upon under the N-Session. On the other hand, consumers might be required to enter credit card details before starting any N-Session.

The B2B negotiation sub-product is destined for suppliers who wish to negotiate and close deals with other suppliers by using an automatic negotiation system (ANS). The nature of these deals is such that the buyer does not buy a single piece of a product, but instead acquires a relatively large quantity of each product, as in buying from wholesalers. Unlike the case of B2C deals, B2B negotiations are more complicated and might include not only a one-time deal, but also a long-term contract that covers sale of the same products repeatedly over a certain period of time. As a result, the present invention is designed to support e-Contracts.

Support of e-Contracts enables the inclusion of another body that can act as the business buyer (B-Buyer) in such deals—corporations that are interested in closing a deal for buying certain products, where the purchase is done repeatedly for different products over along period of time. An example is a contract in which a large corporation receives a certain discount on all products acquired by the corporation for a period of three months.

While consumers close deals simply by agreeing to buy the product for the negotiated price, businesses usually need a more firm agreement, in the form of a contract that details all aspects of the deal closed. Deal aspects can include the agreed discount for a fixed number of products or it can include a discount agreed per a quantity of products sold. B2B is designed to support different types of contracts, as different contracts might be required depending on the type of product or the type of the sale.

In the case of B2B, how an N-Session is conducted, depends on the type of deal the B-Buyer is interested in. If the B-Buyer is interested in a simple onetime deal, he can use very much the same tools that are employed by consumers. However, if the two parties agree on a contracted N-Session, the session is composed of a series of phases that together construct an agreed-upon contract. The main difference between the two methods lies in the structure of the N-Session. A consumer N-Session is usually lead by the consumer, where the consumer can decide which term of the deal he's interested in negotiating, in any order he chooses, as “agreements” between a seller using the present invention software and a consumer are of a more flexible and lenient nature. A B2B N-Session for an e-Contract has a predefined structure, where the two parties kind of “go over” the contract, item by item, till all items are discussed and an agreement over the whole contract is reached.

### BRIEF DESCRIPTION OF THE DRAWINGS

FIG. 1 illustrates a typical travel product B2C N-session using the present invention.

FIG. 2 illustrates a typical travel product B2B N-session using the present invention.

FIG. 3 illustrates negotiable items for travel related vendors.

FIG. 4 illustrates a flowchart of a session start of a negotiation.

FIG. 5 illustrates a flowchart of a session of a negotiation.

FIG. 6 illustrates a flowchart of a session closing a negotiation.

FIGS. 7a-7d illustrate a collection of working examples exemplifying various elements of the present invention.

### DESCRIPTION OF THE PREFERRED EMBODIMENTS

While this invention is illustrated and described in a travel product related preferred embodiment, the device may be produced in many different applications, configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

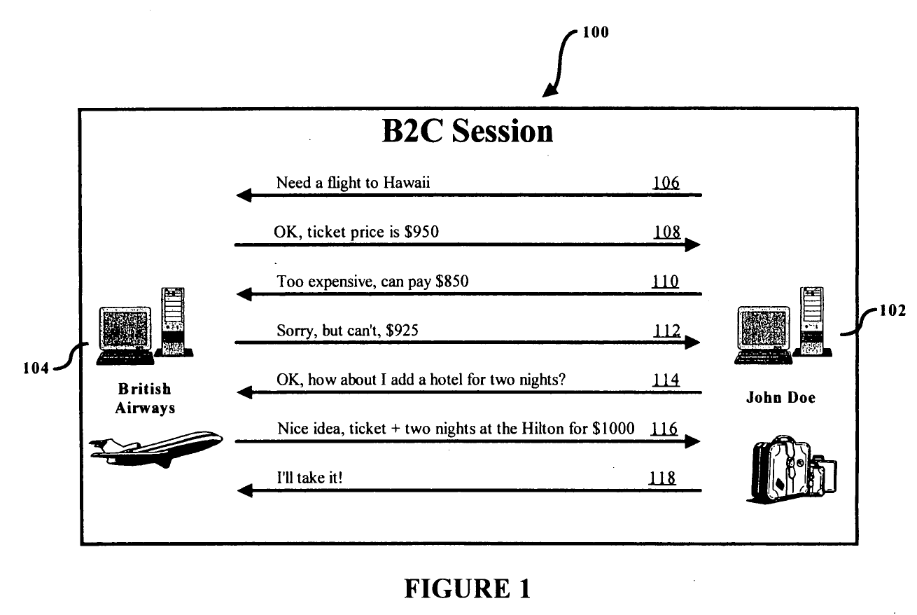

FIG. 1 illustrates a typical travel product B2C N-session 100 using the present invention. In this N-session, consumer John Doe 102 electronically negotiates with supplier British Airways□ 104 to purchase a flight to Hawaii 106. A request is made to British Airways for the flight 106, the present invention returns a default ticket price offer of $950 108 as stored in a database. The consumer counters with $850 110. The system lowers the default offer by some predetermined amount/percentage, in this case $25 112. The consumer modifies the parameters of the negotiation by adding a request for a package including the original flight as well as a hotel room 114. The system counters with a confirmation of acceptance, including the suggested parameters and price per unit for this acceptance 116. The consumer confirms acceptance 118. The system would then enter a financial acquisition stage, not shown, which in some sessions would be included as part of the negotiation, i.e., the terms of payment may be a consideration.

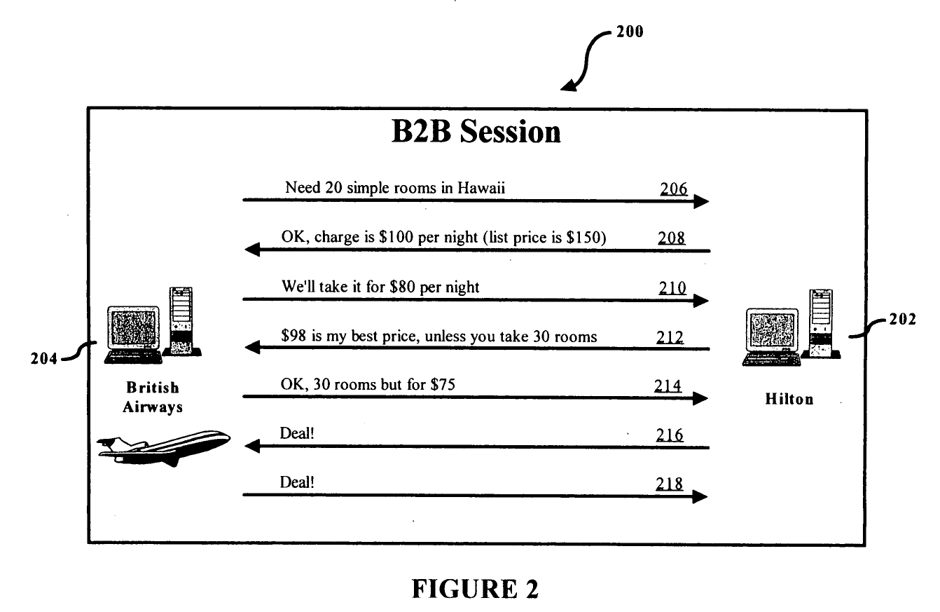

FIG. 2 illustrates a typical travel product B2B N-session 200 using the present invention. In this N-session, supplier Hilton□ 202 electronically negotiates with supplier British Airways□ 204 to purchase a supply of rooms in Hawaii 206. A request is made from British Airways for 20 rooms 206, the present invention returns a default room price offer of $100/night and suggested list price 208 as stored in a database. The system lowers the offer by some predetermined amount/percentage, in this case $20 to $80 and returns it to Hilton 210. The Hilton system offers a minimum price for this volume according to preset price limitations, but offers a default price below the original offer at a different volume, thereby modifying the parameters of the negotiation 212. The British Airways' system counters with a confirmation of acceptance, including the newly suggested parameters and a new price per unit for this acceptance 214. The system confirms acceptance from both businesses 216 and 218.

The B2C and B2B sub-products of the present invention come with a built-in ability to negotiate simple deals as well as complex contracts. As the art of negotiation for sales and purchasing varies from supplier to supplier, this built-in ability is not enough. There must be a way for a supplier to conduct negotiations his way. This is where the present invention rule system comes handy.

A user of the software of the present invention can decide to use the default negotiation mechanism in some cases and override it in others. The intervention is done by defining rules that identify negotiation situations that need intervention and then defining rules that instruct the system what to do in such situations. Different types of rules are supported for different purposes, as described hereafter.

Once new rules are defined, they are stored in a database. Then, a simulation mechanism is used to verify the validity and acceptance of the newly defined rules. The simulation can help with detecting problematic rules that might cause a different behavior than the one expected by the person/business that defined them. In addition to controlling negotiations, rules can be defined to control the way the present invention is used by a user of the software (e.g., security and responsibility issues).

The following types of rules are supported by the present invention:

Negotiation—Threshold Rules

These rules enable suppliers to specify starting terms for each N-Session, depending on various pieces of information, such as—what is known on the N-Session's other party. They can also be used to determine the maximum length of an N-Session and what is the minimum by which each price bid should increase. A supplier which is an airline, can set a rule to allow for discussion of payment terms (such as the number of installments), only when the consumer is a member of the airline's frequent flyers' program. In very much the same way, B-Suppliers can decide to allow discussion of payment terms only to B-Buyers that have a long record of purchasing from those B-Suppliers.

Negotiation—Negotiation Management Rules

The rules enable an operator of the present invention to relate to different situations that can arise during an N-Session and indicate what would be the appropriate reaction in such situations.

Assume a user of the software of the present invention has requested (by setting the appropriate value in the database), that the minimum price negotiable for a certain product will be set at $40. A rule can be defined that will increase or decrease this value according to the behavior of the N-Session's partner. For instance, a supplier can decide that consumers must increase each bid by at least $1 and then, decide that any consumer that bargains for more than 20 N-Iterations (i.e., repeats the offer/counteroffer sequence more than twenty (20) times)—is considered “problematic”.

Based on the above, the supplier can set a rule that will increase the minimum price by $5 if there are more than 20 N-Iterations in a given session, making the new minimum price $45. This results in a kind of “punishment” for such “problematic” consumers.

Negotiation—Yield Management Rules

These rules enable suppliers to relate to how good or bad negotiations go with all products or with all or some of the consumers that are negotiating for the same product. It can also relate to the number of items remaining for a product or to the average number of items sold at a certain time of year. Rules can be defined to alter the negotiation course depending on what happens with other consumers that negotiate the product. As an example, a rule can be defined to check the pace in which products are sold and if products are sold below a certain rate (e.g., less than 5 per hour), all negotiations for these products will be willing to close deals for lower prices.

Administration—Security Rules

Unlike the other types of rules, these rules enable a user of the present invention to determine internal policies pertaining to the internal use of the present invention. Thus, a rule can be set to define which user is allowed to define which type of negotiation rules. These rules can be based on attributes such as the user's position, division or on the time of the day.

N-Sessions Include Various Stages:

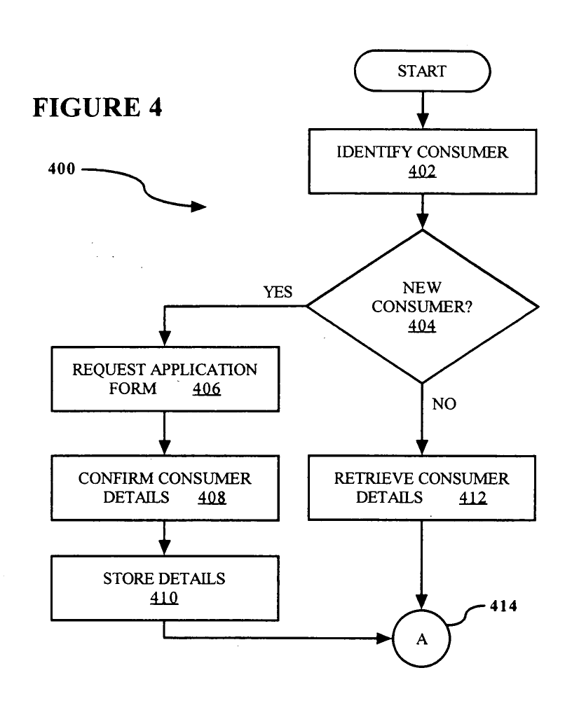

Initiation (FIG. 4):

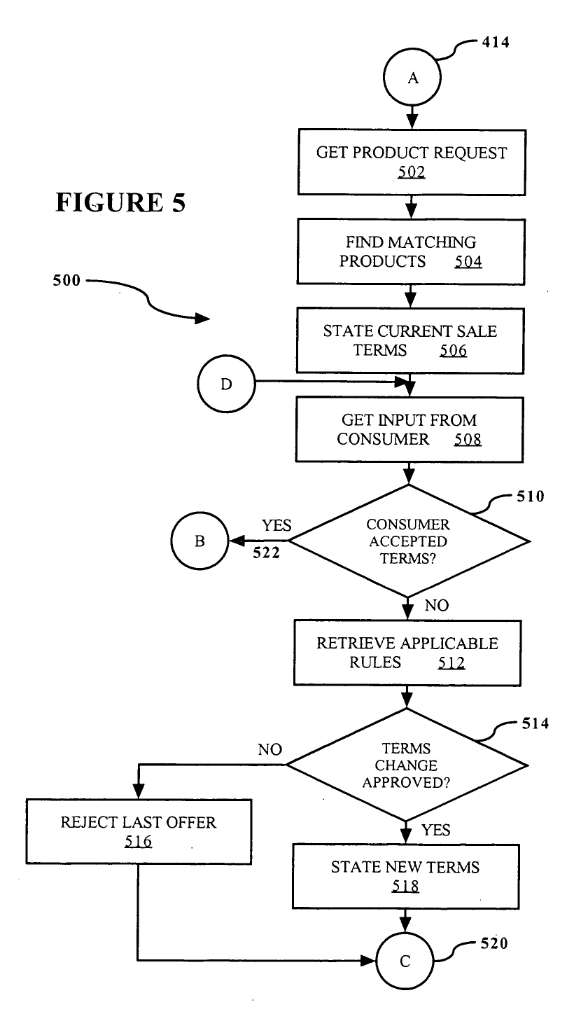

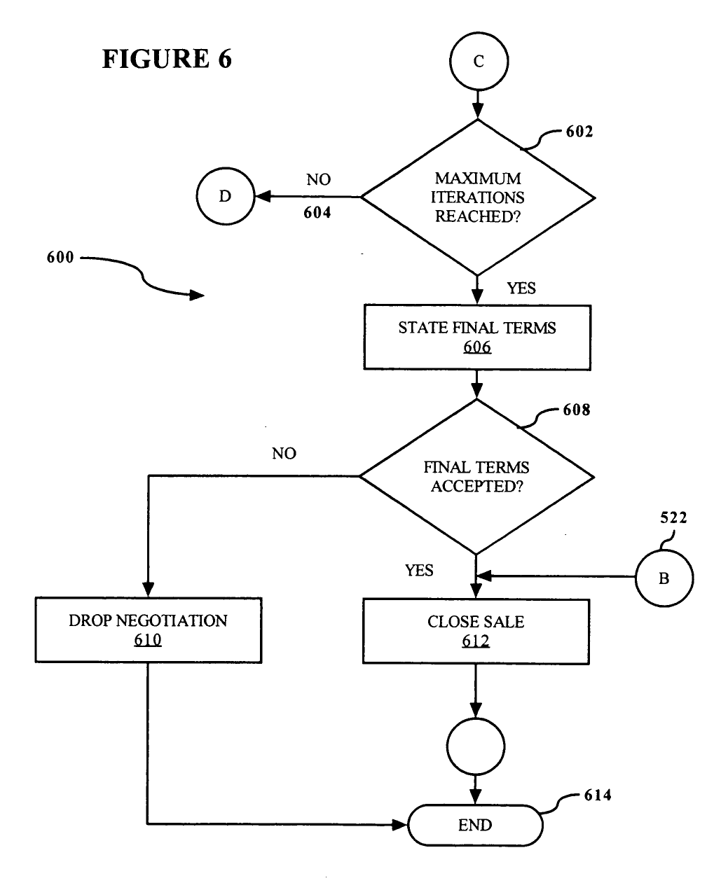

A B2C Session typically starts with performing the following actions 400:
check for the identity of the negotiator 402;
if this is a new consumer, the system might request an application form 406, confirm consumer details 408, and store details 410;
if this is a prior consumer, retrieve and analyze the negotiator's history 412,
   analyze and apply defined rules to the N-Session that is about to begin 414,
continuing in FIG. 5, the session continues 500 with:
   get travel product request 502,
   find matching travel products 504,
   present the N-Session opening sale terms (threshold requirements) to the negotiator 506, and
   get the negotiator's approval of the above requirements which includes:
      get input from consumer 508,
      if consumer accepted the current sale terms, go to close the sale as shown in FIG. 6 element 522, else (i.e., the consumer entered a new terms offer),
      retrieve applicable rules 512,
      check to see if terms change is approved, if not, reject the last offer 516 and continue to FIG. 6 flow, else if offer terms are approved, state the system's new terms (based on the consumer's offer) 518 and proceed to FIG. 6 flow.

FIG. 6 illustrates a conclusion of the negotiations 600, as follows:
continue only if a preset maximum number of iterations has not been reached 602, return to 508 otherwise 604,
state the final terms 606,
if the final terms are not accepted 608, terminate the session 610, otherwise,
close the sale 612 using common financial methods and end 614.
   Termination

An N-Session is terminated in any of the following situations:
the negotiated product is sold-out,
the present invention is unhappy with the negotiator's responses,
the negotiator quit the negotiation,
a rule was defined to terminate the N-Session when certain conditions are met,
the negotiating parties have reached an agreement or hardware problems have caused the premature termination of the session
   N-Sessions Agenda

As negotiating the price of a product is the most basic thing to do, it is safe to assume that most of the N-Sessions will discuss price. However, unlike the prior art, the present invention supports the negotiation of various issues; the negotiator can ask for discussion of any of the supported issues, provided that the supplier allowed discussion of them.

As in reality, negotiation can be very tiring and a waste of time. Also, there's always the possibility of having to negotiate with one that has no real intention of buying. Finally, there's the issue of individuals or even better—smart—agents that might try to run N-Sessions on and on, using different tactics, until they reach a good price.

To alleviate the above problems, the present invention, in one embodiment, is instructed (via rules) to impose a limit on N-Sessions. Examples for such limits are:
maximum number of N-Iterations allowed in one session,
maximum number of issues that can be raised,
the type of issues that can be discussed or
a price (or a higher price) that is imposed on the negotiator per N-session or per response.

These limitations can be predefined or they can be activated during the N-Session, according to the negotiator's responses. In addition, different limitations can exist for different negotiators. A negotiator that has a long history of buying products from the supplier or one that is a member of an airline's frequent-flyer club, can get less restricting limitations than other negotiators.

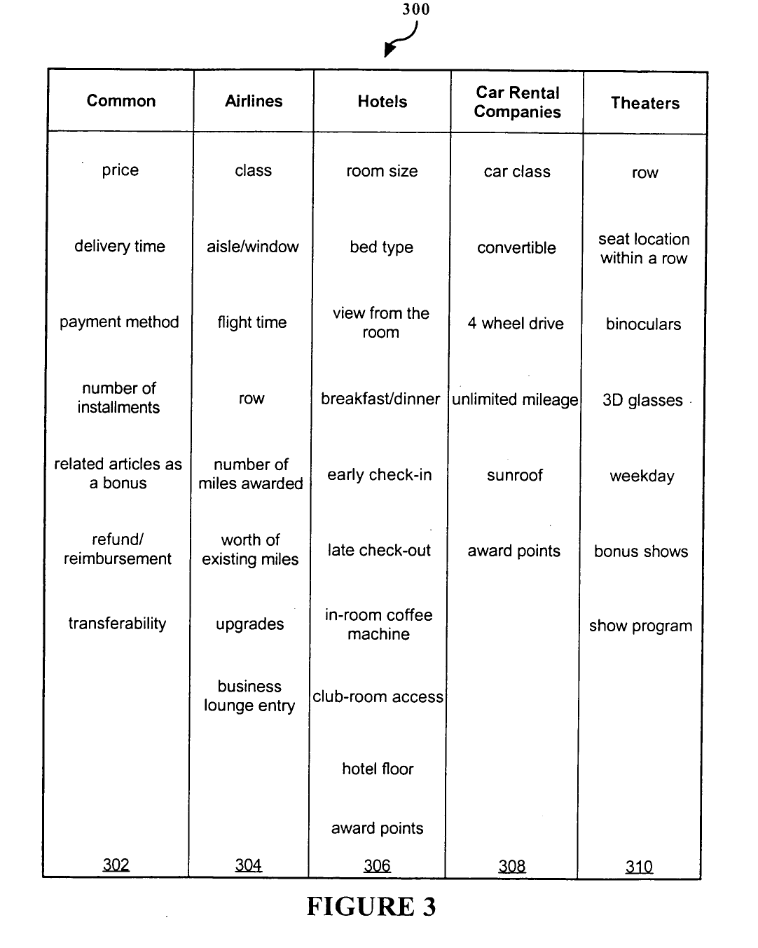

The following are examples of issues that can be raised and negotiated during an N-Session: FIG. 3 illustrates potential negotiable items 300 for travel related vendors. Travel product suppliers include, but are not limited to, airlines, hotels, car rental companies, movie theaters, restaurants, limousine companies, cruise companies, sports clubs, amusement parks, theaters (operas, plays), special attractions (e.g., the Eiffel Tower), concerts and travel books and map sellers. Travel products buyers include, but are not limited to, individual leisure travelers, business travelers (individuals or companies), travel agents and wholesalers. Common items 302 include:
a product's price,
payment terms (e.g., number of installments, credit card, or check, etc.),
delivery time (e.g., immediate shipment),
quantity (i.e., purchase of several items might yield a better price per item),
upgrades (e.g., the parties might start with a class A car and close on a price for a Class B car),
cross-sales (e.g., the parties might start with a flight and then add a car and hotel into the deal),
product specifics (e.g., take midday or midnight flight) or
extra benefits (e.g., number of points awarded to the membership card for taking a flight).

Airlines 304, hotels 306, car rental companies 308 and theaters 310 also have default items specific to their industry. These lists are not to be considered exhaustive, but are representative of popular items. Additional items, deemed important to the negotiator, may be added without departing from the scope of the present invention. The present invention can enable a discussion of any of the items that are labeled as negotiable.

During the course of a negotiation, the present invention can decide (either through its default mechanism or via a defined rule), to give the negotiator a hint about what price could close the deal for the benefit of both sides. Thus, instead of having the present invention answer with a simple yes or no, or with a reduction of a percent each time, it can come up with a counteroffer. This counteroffer can be the derivative of what was learned during that N-Session, it can be the result of analyzing the negotiator's profile or it can be the result of analysis of the global status of sales for the negotiated product.

Several exceptional situations might exist that the present invention is able to deal with, both by default and via supplier defined rules. Examples for such exceptions are: a buyer is offering a price which is higher than the requested price, an N-Session is terminated without prior notice or a buyer is offering a lower price than a price he has accepted a moment ago. A user can define the results of these exceptions to fit their requirements or base them on a historical analysis.

Smart-Agents are software tools that impose as buyers and then attempt to query a price (in the more simple case), or negotiate a price, where sophisticated actions are involved. Apart from using limitations on N-Sessions as described above, the present invention is able to deal with such attempts with the following:
maintaining a negotiation engine that uses many negotiation decisions factors, making it very difficult for Smart-Agents to make an educated guess on how to beat the present invention,
comparing the general format of an N-Session to the general format of other N-Sessions, in an attempt to find a repeated method of operation, making the buyer a suspect for being a Smart-Agent or
charging money per N-Session.

There are reasons for the user to decide that entering an N-Session requires some sort of payment. The reasons can be:
getting rid of parties that have no real intention to buy or that play for chance,
making it not worthwhile for Smart-Agents to negotiate,
giving the negotiation mechanism a more serious look and feel or
earning even when a deal is not closed.

The payments can be done:
per N-Session or series of N-Sessions,
per N-Iteration or series of N-Iterations,
for elapsed time—per an hour, per a day or
a monthly fee, annual fee or even a one time payment.

The specific payment methods are of no interest to the present invention. However, the present invention supports negotiation payments by allowing the following:
definition of required credit points per unit of use
maintaining credit points balance, and constantly displaying it to the negotiator or
use of membership points as a valid payment means.

The present invention allows for N-Sessions that do not result in actual purchase and stock update. This allows the user of the software of the present inventions to easily test new rules in a real session, before the rules are applied to real negotiations. Despite the automatic nature of the present invention, users of the present invention always have means to manually intervene in an N-Session and replace the present invention automatic responses with their own responses and decisions. Running N-Sessions can be viewed and explored using the present invention real-time monitor, described hereafter.

The present invention offers the following for N-Sessions that terminated with agreement of both sides on a deal:
a summary of the N-Session details,
an update of the buyer's purchase, and/or
statistical data and analysis of the N-Session.

For each carried N-Session, a log is maintained that keeps track of every message that was exchanged between the two parties during that session. This is essential for being able to clear questions that arise after an N-Session has been terminated.

The present invention supports monitoring of all events that were processed by it. Monitoring of what happens can be used to:
watch over local transactions made with the present invention by a certain supplier, and provide the user of the software of the present invention with the relevant information.
collect global information and provide it to some or all users.

Monitoring of local transactions allows for:
collection and display local statistics (e.g., number of walk-away negotiations, average negotiation length),
reporting on exceptions (e.g., negotiations that take too long, products that are not sold), and
raising alerts, identifying and pointing to negotiations that need immediate intervention

Shared information is a powerful advantage. The decision to share information can be made individually, allowing some users of the present invention to share general information while others do not. Monitoring of all transactions through one focal point, allows for:
measuring the global average length of a negotiation and handle negotiations that exceed that, as exceptions,
positively recommending prices that are found in the system to be effective,
preventing consumers from negotiating concurrently (e.g., forbid negotiation of the same product concurrently either globally or with a specific supplier),
preventing fraud by not allowing for the same negotiator to negotiate too many deals concurrently,
revealing product combinations that sell very well, and
sharing learned information about tactical mistakes made in negotiations.

As in real world negotiations, disputes may arise that are the result of misunderstanding, fraud and either human or computer mistakes, the present invention has the following features, in support of dispute resolution:
complete negotiation log—enabling to track negotiations that happened in the past,
closed contracts archive—when an argument exists over the specifics of what was agreed, and
confirmation of deal details is required,—supply negotiation log electronically upon request. This also allows for a validation means when a claim is raised in a negotiation that says something like “I got better terms from supplier x”.

The following session example describes a general consumer to business negotiation session:
C=consumer; A=ANS
C: Need a flight from NY to SF, in coach class.
A: List Price: $2,980, Negotiable items: price, membership points, hotel room reservation; 15 iterations allowed in current session.
C: Willing to pay $2,400.
A: You can get a price of $2,900.
C: How about $2,500 and 500 membership points?
A: 500 membership points yield a price of $2,750.
C: How about 1,000 membership points?
A: 1,000 points will get a price of $2,700.
C: OK, how about 1 add a simple room in the Marriot hotel?
A: Marriot not available, $2,750 for the addition of a one night simple room in Holiday Inn.
C: I'll take it.
A: Pay: $2,750+1,000 membership points
   Purchase: Flight, NY-SF+one night in Holiday Inn
   Reservation number: 972477337374
   Credit card charged, receipt sent by e-mail

Database Contents

List price of flight from NY to SF is $2,980, minimum price is set at $2,000.

List price of one night in Holiday Inn in SF, is $154, minimum price is set at $50.
Customers purchase history and membership details.

Rules Defined for Above Session
1. If initial price offer from consumer is more than 80% of list price:
   Response=offer random-discount of between 2 and 7 percent otherwise Response=reject offer;
   Message=“Declined, please re-offer”
2. If offer-type is membership-points:
   first 500 points=$150; above 500 points=$50
3. if new-price-offer-from-consumer>3% of last-offer-from-consumer:
   and price-change-count<=3: Response=offer discount of 0.1% otherwise if new-offer-from-consumer>3% of last-offer-from-consumer and price-change-count>3
   Response=reject offer;
   Message=“Current terms disable better price” otherwise
   Response=reject offer; Message=“Declined, please re-offer”
4. If hotel-requested:
   and consumer is frequent flier and hotel-list-price-per-night>100 and hotel-price-per-night<200: hotel-price=$50 otherwise hotel-price=list-price−2%
5. set maximum-discount-count=1

Comments:
1. The whole session is presented through the eyes of an airline that owns the ANS.
2. Minimum price in the database is used for protection against rules that yield low prices. Suggested price id derived from the rules without going lower than the minimum price indicated in the database.
3. System defaults are used for general behavior. Thus, if negotiation lasts more than 15 iterations (offer/response), negotiation is terminated with a “take it or leave it” message on the terms agreed in the last iteration. The list of negotiable items is also derived from system defaults.
4. The first rule awards consumers (without their knowledge), for submitting an initial offer within reason.
5. As rule 5 prevents multiple discounts in the same iteration, when the consumer comes up with a request for a charge of $2,500 and 500 membership points, the only rule activated is that of the membership points (as it is applied first in the order the rules are presented).

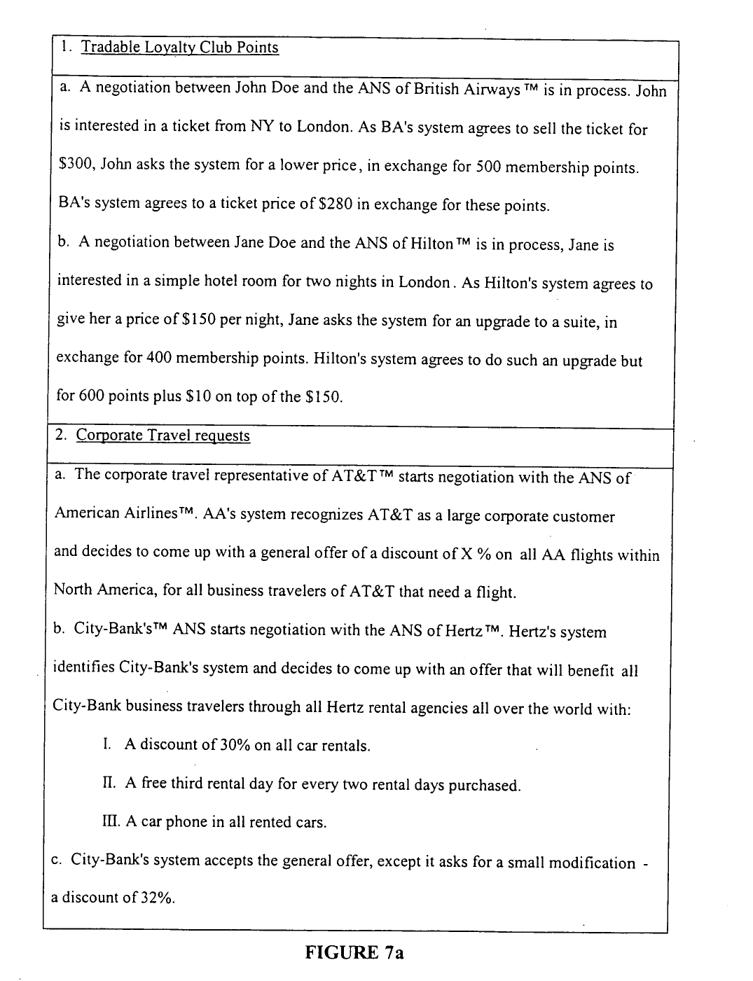

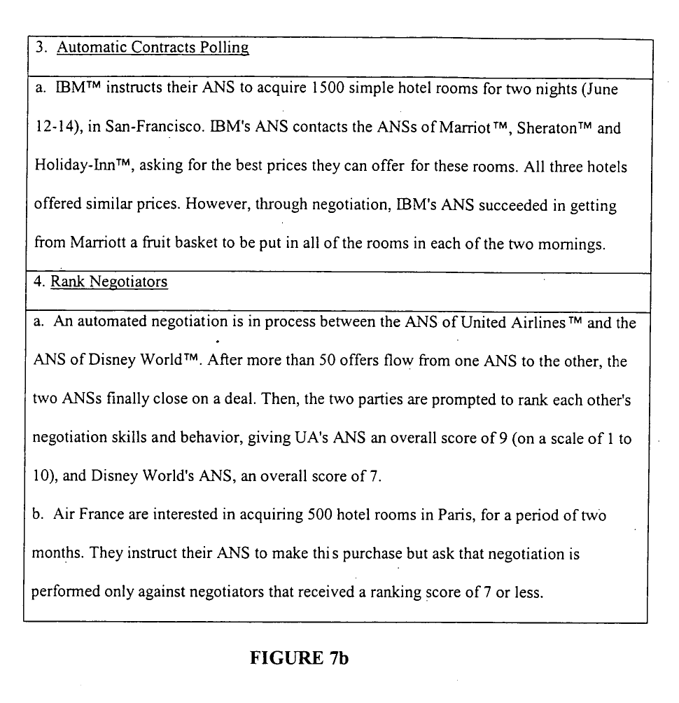

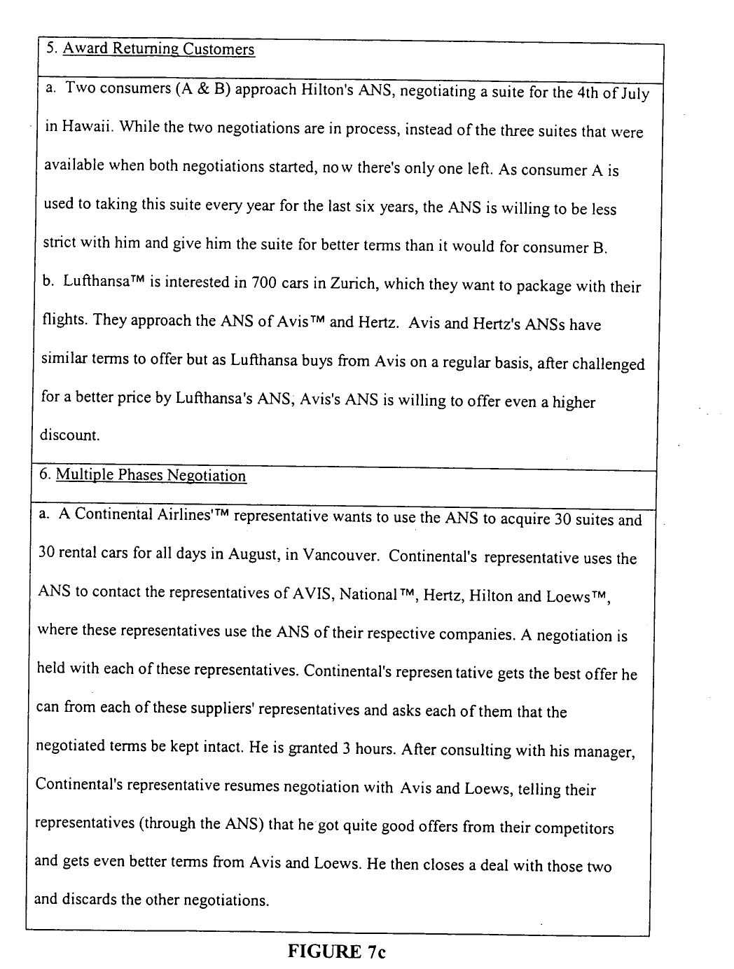

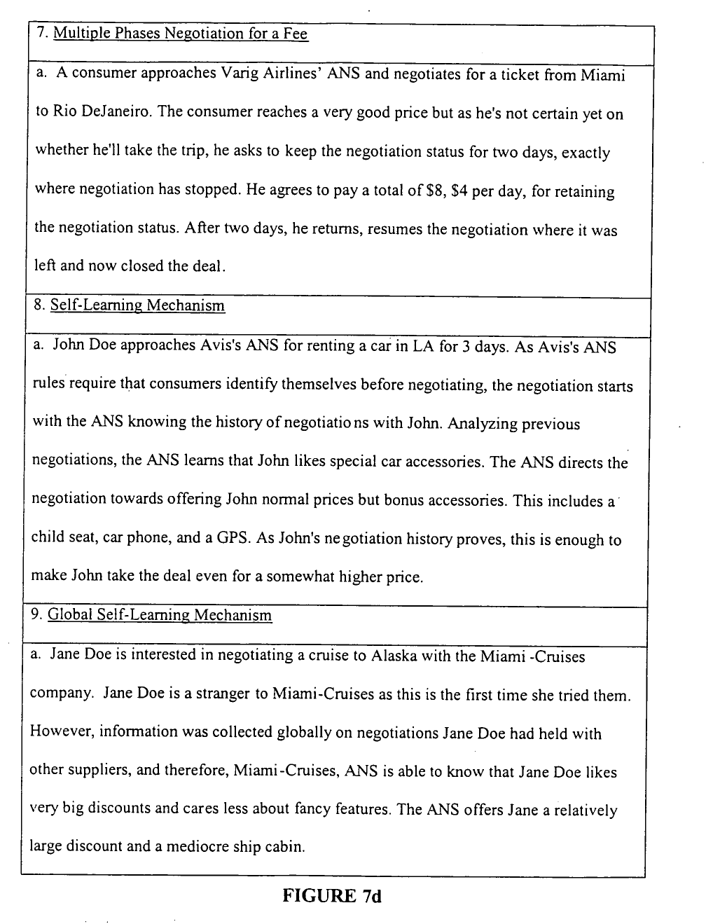

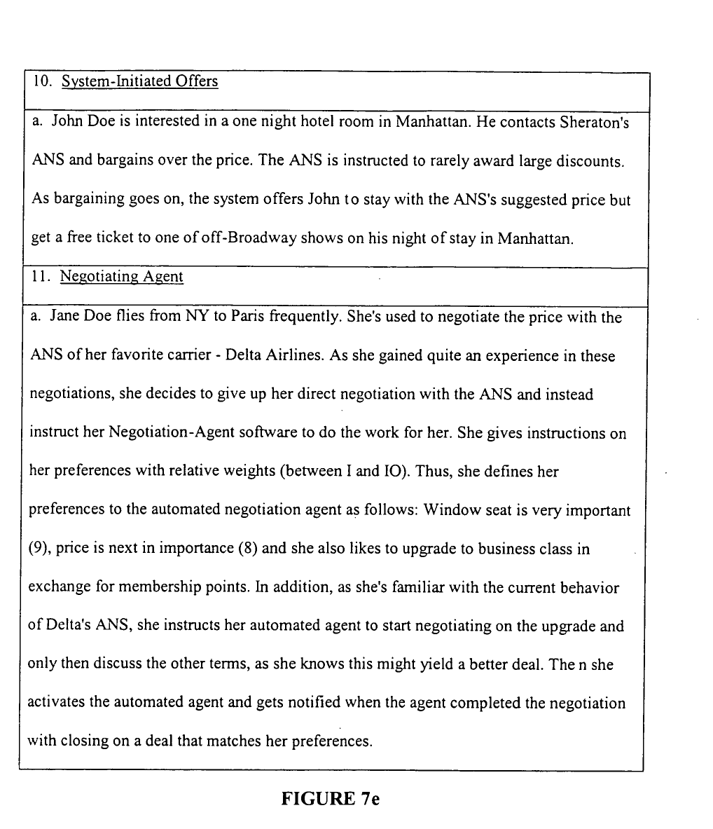

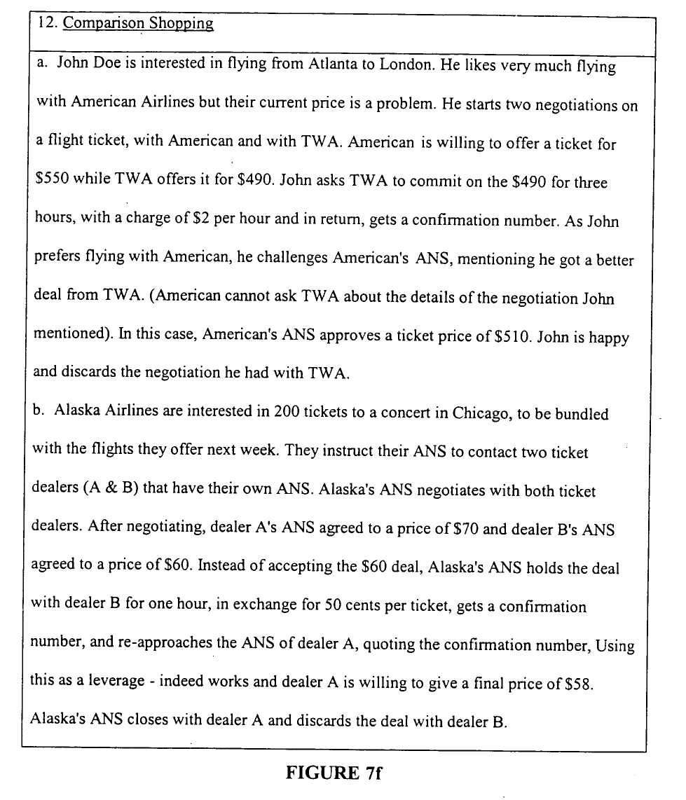

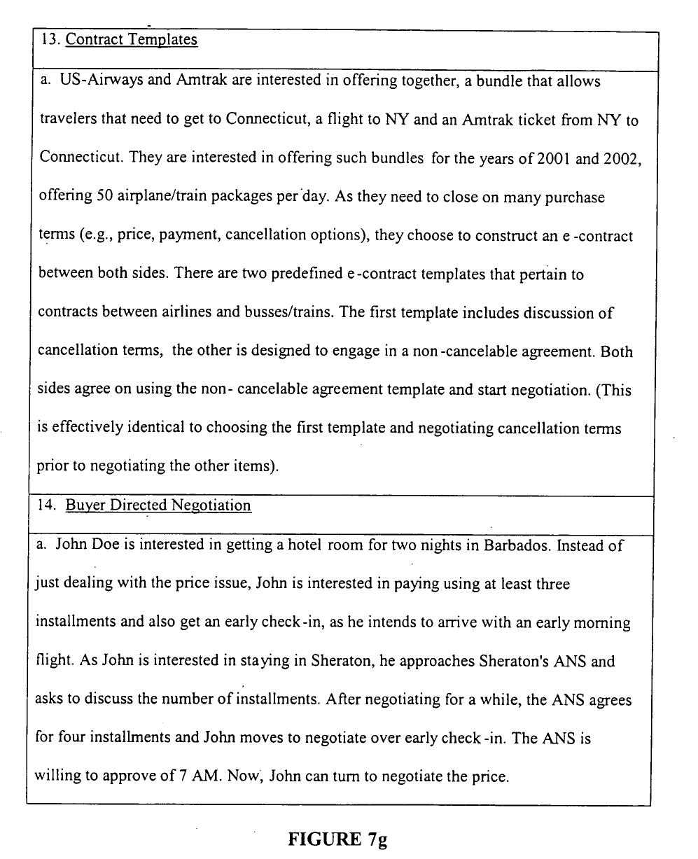

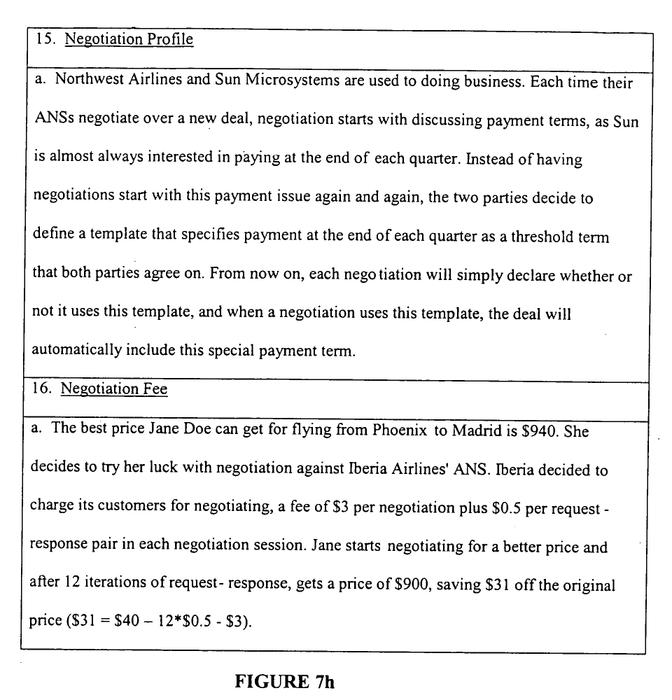

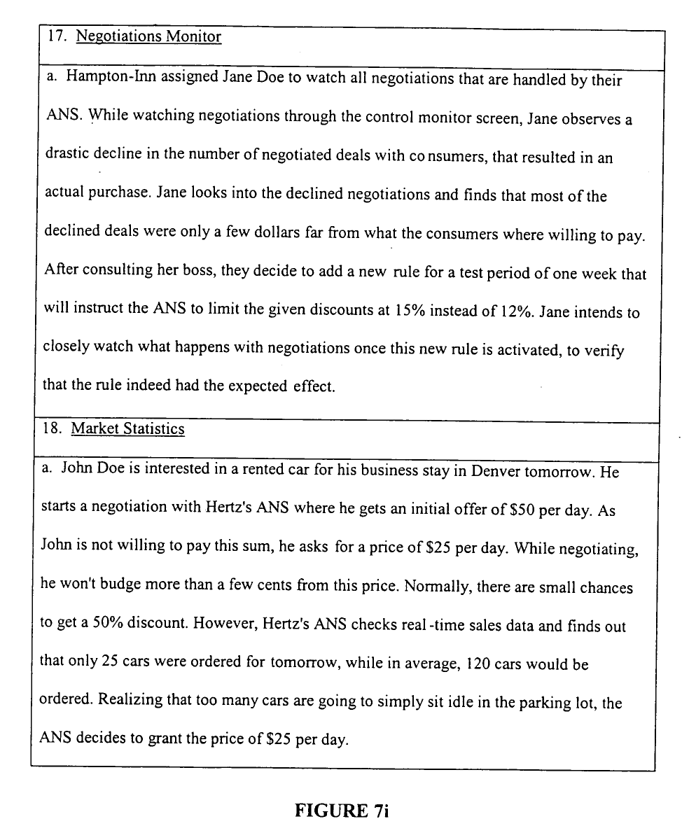

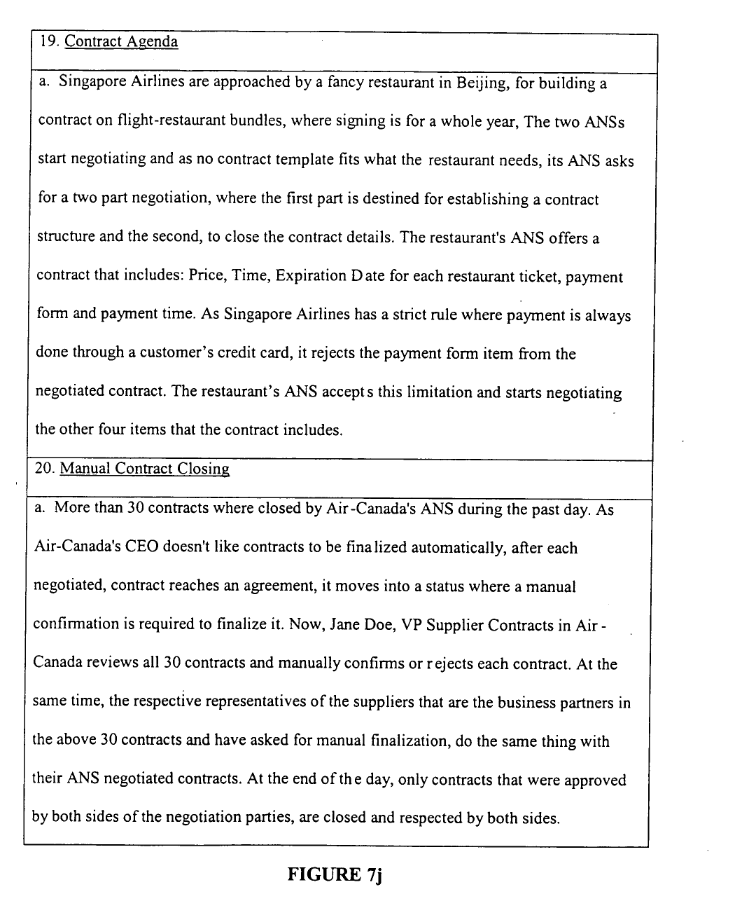

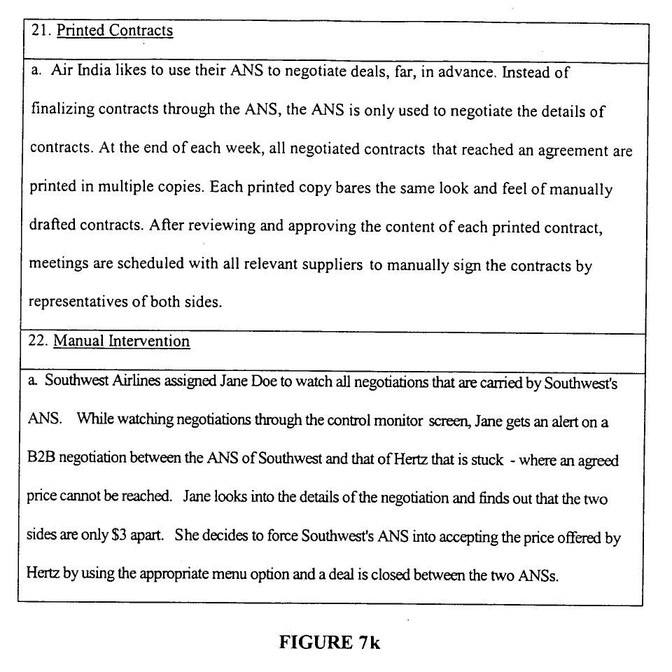

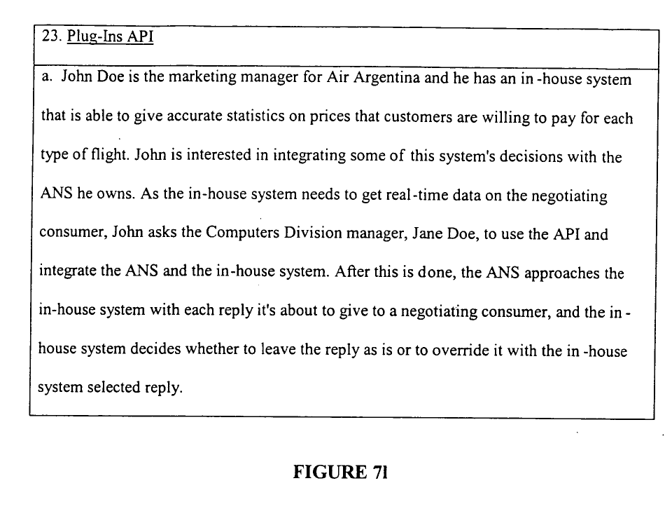

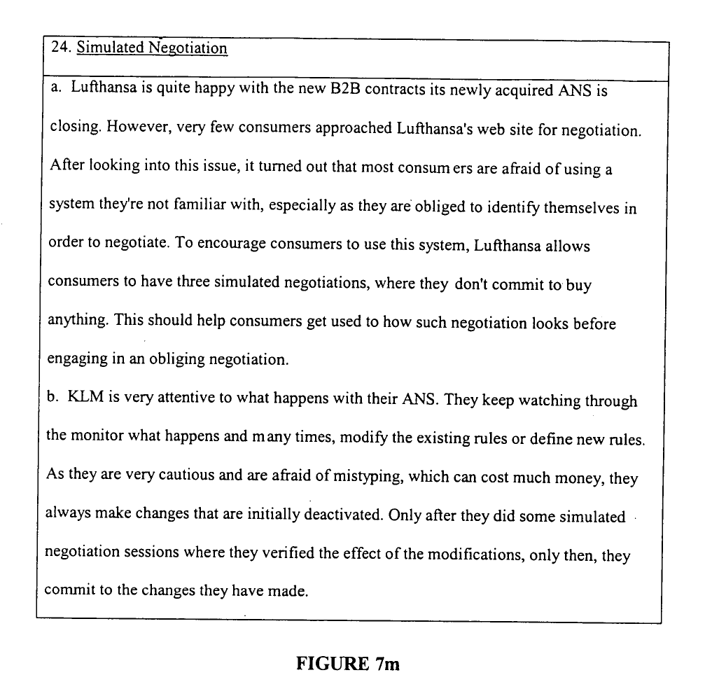

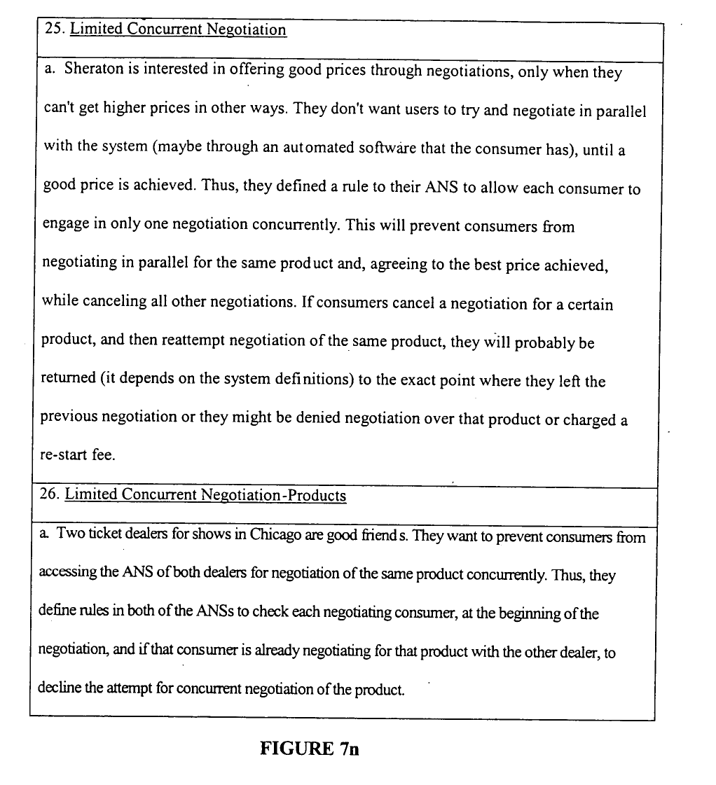

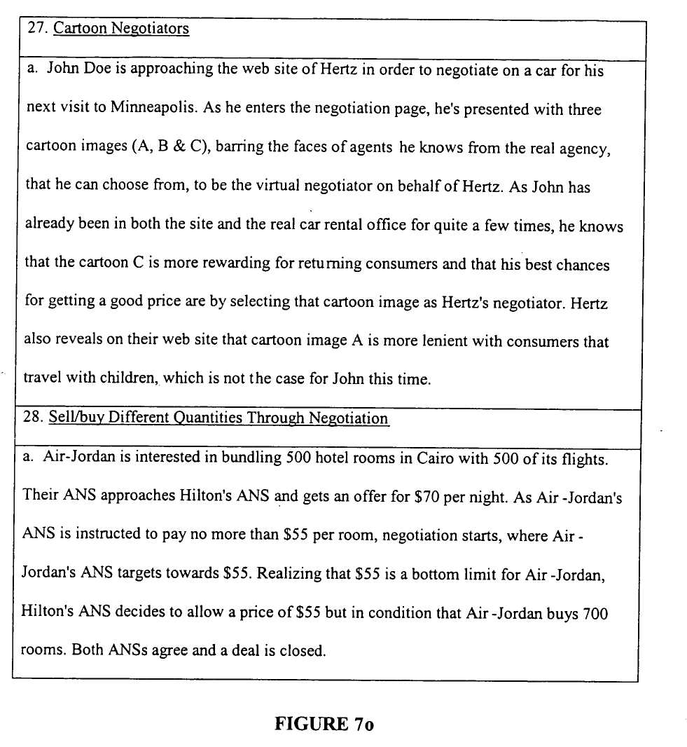

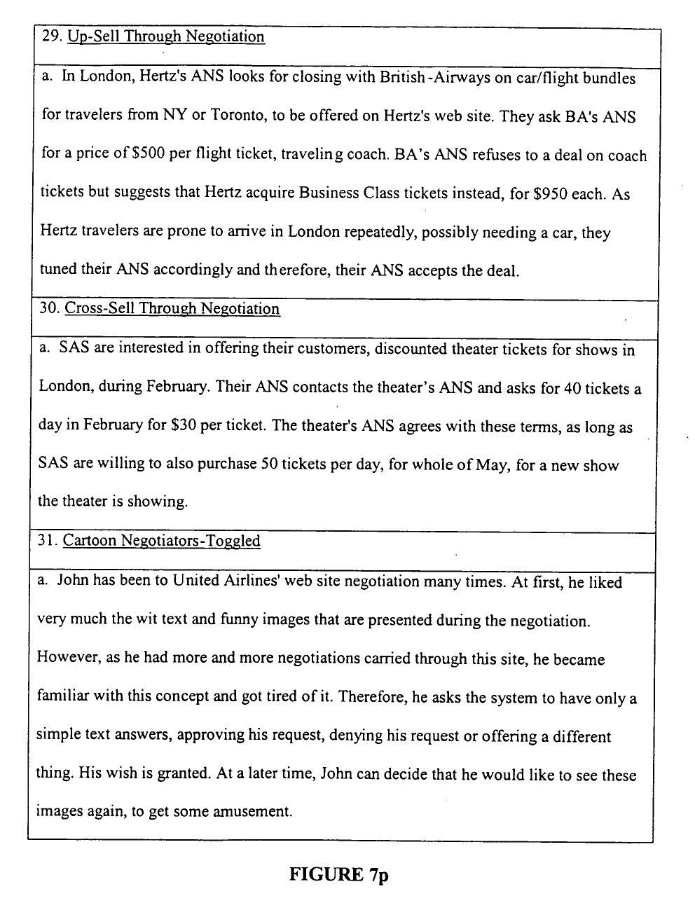

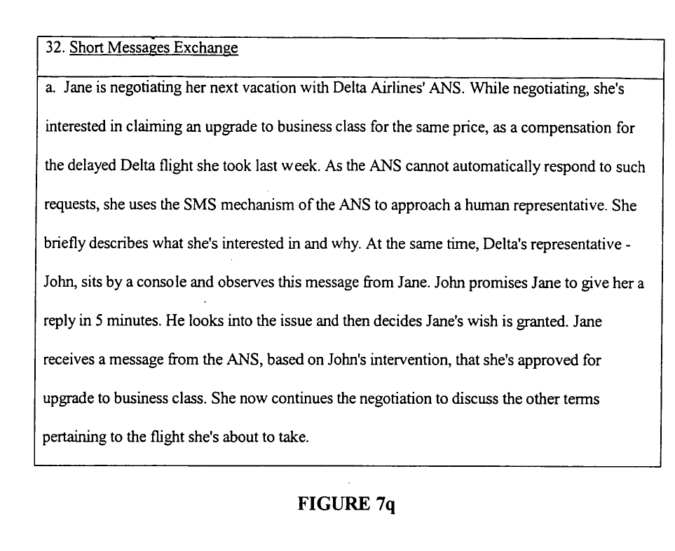

The following additional examples, shown in FIGS. 7a-7q, detail various applications of N-Sessions using the present invention and may assist in developing a fuller more complete understanding of the various features thereof.

1. Tradable Loyalty Club Points

a. A negotiation between John Doe and the ANS of British Airways□ is in process. John is interested in a ticket from NY to London. As BA's system agrees to sell the ticket for $300, John asks the system for a lower price, in exchange for 500 membership points. BA's system agrees to a ticket price of $280 in exchange for these points.

b. A negotiation between Jane Doe and the ANS of Hilton□ is in process, Jane is interested in a simple hotel room for two nights in London. As Hilton's system agrees to give her a price of $150 per night, Jane asks the system for an upgrade to a suite, in exchange for 400 membership points. Hilton's system agrees to do such an upgrade but for 600 points plus $10 on top of the $150.

2. Corporate Travel Requests

a. The corporate travel representative of AT&T□ starts negotiation with the ANS of American Airlines□. AA's system recognizes AT&T as a large corporate customer and decides to come up with a general offer of a discount of X % on all AA flights within North America, for all business travelers of AT&T that need a flight.

b. City-Bank's□ ANS starts negotiation with the ANS of Hertz□. Hertz's system identifies City-Bank's system and decides to come up with an offer that will benefit all City-Bank business travelers through all Hertz rental agencies all over the world with:
I. A discount of 30% on all car rentals.
II. A free third rental day for every two rental days purchased.
III. A car phone in all rented cars.

c. City-Bank's system accepts the general offer, except it asks for a small modification—a discount of 32%.

3. Automatic Contracts Polling

a. IBM□ instruct their ANS to acquire 1500 simple hotel rooms for two nights (June 12-14), in San-Francisco. IBM's ANS contacts the ANSs of Marriot□, Sheraton□ and Holiday-Inn□, asking for the best prices they can offer for these rooms. All three hotels offered similar prices. However, through negotiation, IBM's ANS succeeded in getting from Marriott a fruit basket to be put in all of the rooms in each of the two mornings.

4. Rank Negotiators

a. An automated negotiation is in process between the ANS of United Airlines□ and the ANS of Disney World□. After more than 50 offers flow from one ANS to the other, the two ANSs finally close on a deal. Then, the two parties are prompted to rank each other's negotiation skills and behavior, giving UA's ANS an overall score of 9 (on a scale of 1 to 10), and Disney World's ANS, an overall score of 7.

b. Air France are interested in acquiring 500 hotel rooms in Paris, for a period of two months. They instruct their ANS to make this purchase but ask that negotiation is performed only against negotiators that received a ranking score of 7 or less.

5. Award Returning Customers

a. Two consumers (A & B) approach Hilton's ANS, negotiating a suite for the 4th of July in Hawaii. While the two negotiations are in process, instead of the three suites that were available when both negotiations started, now there's only one left. As consumer A is used to taking this suite every year for the last six years, the ANS is willing to be less strict with him and give him the suite for better terms than it would for consumer B.

b. Lufthansa□ is interested in 700 cars in Zurich, which they want to package with their flights. They approach the ANS of Avis□ and Hertz. Avis and Hertz's ANSs have similar terms to offer but as Lufthansa buys from Avis on a regular basis, after challenged for a better price by Lufthansa's ANS, Avis's ANS is willing to offer even a higher discount.

6. Multiple Phases Negotiation

a. A Continental Airlines'□ representative wants to use the ANS to acquire 30 suites and 30 rental cars for all days in August, in Vancouver. Continental's representative uses the ANS to contact the representatives of AVIS, National□, Hertz, Hilton and Lowes□, where these representatives use the ANS of their respective companies. A negotiation is held with each of these representatives. Continental's representative gets the best offer he can from each of these suppliers' representatives and asks each of them that the negotiated terms be kept intact. He is granted 3 hours. After consulting with his manager, Continental's representative resumes negotiation with Avis and Lowes, telling their representatives (through the ANS) that he got quite good offers from their competitors and gets even better terms from Avis and Lowes. He then closes a deal with those two and discards the other negotiations.

7. Multiple Phases Negotiation for a Fee

a. A consumer approaches Varig Airlines' ANS and negotiates for a ticket from Miami to Rio DeJaneiro. The consumer reaches a very good price but as he's not certain yet on whether he'll take the trip, he asks to keep the negotiation status for two days, exactly where negotiation has stopped. He agrees to pay a total of $8, $4 per day, for retaining the negotiation status. After two days, he returns, resumes the negotiation where it was left and now closed the deal.

8. Self-Learning Mechanism

a. John Doe approaches Avis's ANS for renting a car in LA for 3 days. As Avis's ANS rules require that consumers identify themselves before negotiating, the negotiation starts with the ANS knowing the history of negotiations with John. Analyzing previous negotiations, the ANS learns that John likes special car accessories. The ANS directs the negotiation towards offering John normal prices but bonus accessories. This includes a child seat, car phone, and a GPS. As John's negotiation history proves, this is enough to make John take the deal even for a somewhat higher price.

9. Global Self-Learning Mechanism

a. Jane Doe is interested in negotiating a cruise to Alaska with the Miami-Cruises Company. Jane Doe is a stranger to Miami-Cruises as this is the first time she tried them. However, information was collected globally on negotiations Jane Doe had held with other suppliers, and therefore, Miami-Cruises, ANS is able to know that Jane Doe likes very big discounts and cares less about fancy features. The ANS offers Jane a relatively large discount and a mediocre ship cabin.

10. System-Initiated Offers

a. John Doe is interested in a one night hotel room in Manhattan. He contacts Sheraton's ANS and bargains over the price. The ANS is instructed to rarely award large discounts. As bargaining goes on, the system offers John to stay with the ANS's suggested price but get a free ticket to one of off-Broadway shows on his night of stay in Manhattan.

11. Negotiating Agent

a. Jane Doe flies from NY to Paris frequently. She's used to negotiate the price with the ANS of her favorite carrier—Delta Airlines. As she gained quite an experience in these negotiations, she decides to give up her direct negotiation with the ANS and instead instruct her Negotiation-Agent software to do the work for her. She gives instructions on her preferences with relative weights (between I and IO). Thus, she defines her preferences to the automated negotiation agent as follows: Window seat is very important (9), price is next in importance (8) and she also likes to upgrade to business class in exchange for membership points. In addition, as she's familiar with the current behavior of Delta's ANS, she instructs her automated agent to start negotiating on the upgrade and only then discuss the other terms, as she knows this might yield a better deal. Then she activates the automated agent and gets notified when the agent completed the negotiation with closing on a deal that matches her preferences.

12. Comparison Shopping

a. John Doe is interested in flying from Atlanta to London. He likes very much flying with American Airlines but their current price is a problem. He starts two negotiations on a flight ticket, with American and with TWA. American is willing to offer a ticket for $550 while TWA offers it for $490. John asks TWA to commit on the $490 for three hours, with a charge of $2 per hour and in return, gets a confirmation number. As John prefers flying with American, he challenges American's ANS, mentioning he got a better deal from TWA. (American cannot ask TWA about the details of the negotiation John mentioned). In this case, American's ANS approves a ticket price of $510. John is happy and discards the negotiation he had with TWA.

b. Alaska Airlines are interested in 200 tickets to a concert in Chicago, to be bundled with the flights they offer next week. They instruct their ANS to contact two ticket dealers (A & B) that have their own ANS. Alaska's ANS negotiates with both ticket dealers. After negotiating, dealer A's ANS agreed to a price of $70 and dealer B's ANS agreed to a price of $60. Instead of accepting the $60 deal, Alaska's ANS holds the deal with dealer B for one hour, in exchange for 50 cents per ticket, gets a confirmation number, and re-approaches the ANS of dealer A, quoting the confirmation number, Using this as a leverage—indeed works and dealer A is willing to give a final price of $58. Alaska's ANS closes with dealer A and discards the deal with dealer B.

13. Contract Templates

a. US-Airways and Amtrak are interested in offering together, a bundle that allows travelers that need to get to Connecticut, a flight to NY and an Amtrak ticket from NY to Connecticut. They are interested in offering such bundles for the years of 2001 and 2002, offering 50 airplane/train packages per day. As they need to close on many purchase terms (e.g., price, payment, cancellation options), they choose to construct an e-contract between both sides. There are two predefined e-contract templates that pertain to contracts between airlines and busses/trains. The first template includes discussion of cancellation terms, the other is designed to engage in a non-cancelable agreement. Both sides agree on using the non-cancelable agreement template and start negotiation. (This is effectively identical to choosing the first template and negotiating cancellation terms prior to negotiating the other items).

14. Buyer Directed Negotiation

a. John Doe is interested in getting a hotel room for two nights in Barbados. Instead of just dealing with the price issue, John is interested in paying using at least three installments and also get an early check-in, as he intends to arrive with an early morning flight. As John is interested in staying in Sheraton, he approaches Sheraton's ANS and asks to discuss the number of installments. After negotiating for a while, the ANS agrees for four installments and John moves to negotiate over early check-in. The ANS is willing to approve of 7 AM. Now, John can turn to negotiate the price.

15. Negotiation Profile

a. Northwest Airlines and Sun Microsystems are used to doing business. Each time their ANSs negotiate over a new deal, negotiation starts with discussing payment terms, as Sun is almost always interested in paying at the end of each quarter. Instead of having negotiations start with this payment issue again and again, the two parties decide to define a template that specifies payment at the end of each quarter as a threshold term that both parties agree on. From now on, each negotiation will simply declare whether or not it uses this template, and when a negotiation uses this template, the deal will automatically include this special payment term.

16. Negotiation Fee

a. The best price Jane Doe can get for flying from Phoenix to Madrid is $940. She decides to try her luck with negotiation against Iberia Airlines' ANS. Iberia decided to charge its customers for negotiating, a fee of $3 per negotiation plus $0.5 per request-response pair in each negotiation session. Jane starts negotiating for a better price and after 12 iterations of request—response, gets a price of $900, saving $31 off the original price ($31=$40−12*$0.5−$3).

17. Negotiations Monitor

a. Hampton-Inn assigned Jane Doe to watch all negotiations that are handled by their ANS. While watching negotiations through the control monitor screen, Jane observes a drastic decline in the number of negotiated deals with consumers, that resulted in an actual purchase. Jane looks into the declined negotiations and finds that most of the declined deals were only a few dollars far from what the consumers where willing to pay. After consulting her boss, they decide to add a new rule for a test period of one week that will instruct the ANS to limit the given discounts at 15% instead of 12%. Jane intends to closely watch what happens with negotiations once this new rule is activated, to verify that the rule indeed had the expected effect.

18. Market Statistics

a. John Doe is interested in a rented car for his business stay in Denver tomorrow. He starts a negotiation with Hertz's ANS where he gets an initial offer of $50 per day. As John is not willing to pay this sum, he asks for a price of $25 per day. While negotiating, he won't budge more than a few cents from this price. Normally, there are small chances to get a 50% discount. However, Hertz's ANS checks real-time sales data and finds out that only 25 cars were ordered for tomorrow, while in average, 120 cars would be ordered. Realizing that too many cars are going to simply sit idle in the parking lot, the ANS decides to grant the price of $25 per day.

19. Contract Agenda

a. Singapore Airlines is approached by a fancy restaurant in Beijing, for building a contract on flight-restaurant bundles, where signing is for a whole year, The two ANSs start negotiating and as no contract template fits what the restaurant needs, its ANS asks for a two part negotiation, where the first part is destined for establishing a contract structure and the second, to close the contract details. The restaurant's ANS offers a contract that includes: Price, Time, Expiration Date for each restaurant ticket, payment form and payment time. As Singapore Airlines has a strict rule where payment is always done through a customer's credit card, it rejects the payment form item from the negotiated contract. The restaurant's ANS accepts this limitation and starts negotiating the other four items that the contract includes.

20. Manual Contract Closing

a. More than 30 contracts where closed by Air-Canada's ANS during the past day. As Air-Canada's CEO doesn't like contracts to be finalized automatically, after each negotiated, contract reaches an agreement, it moves into a status where a manual confirmation is required to finalize it. Now, Jane Doe, VP Supplier Contracts in Air-Canada reviews all 30 contracts and manually confirms or rejects each contract. At the same time, the respective representatives of the suppliers that are the business partners in the above 30 contracts and have asked for manual finalization, do the same thing with their ANS negotiated contracts. At the end of the day, only contracts that were approved by both sides of the negotiation parties, are closed and respected by both sides.

21. Printed Contracts

a. Air India likes to use their ANS to negotiate deals, far, in advance. Instead of finalizing contracts through the ANS, the ANS is only used to negotiate the details of contracts. At the end of each week, all negotiated contracts that reached an agreement are printed in multiple copies. Each printed copy bares the same look and feel of manually drafted contracts. After reviewing and approving the content of each printed contract, meetings are scheduled with all relevant suppliers to manually sign the contracts by representatives of both sides.

22. Manual Intervention

a. Southwest Airlines assigned Jane Doe to watch all negotiations that are carried by Southwest's ANS. While watching negotiations through the control monitor screen, Jane gets an alert on a B2B negotiation between the ANS of Southwest and that of Hertz that is stuck—where an agreed price cannot be reached. Jane looks into the details of the negotiation and finds out that the two sides are only $3 apart. She decides to force Southwest's ANS into accepting the price offered by Hertz by using the appropriate menu option and a deal is closed between the two ANSs.

23. Plug-Ins API

a. John Doe is the marketing manager for Air Argentina and he has an in-house system that is able to give accurate statistics on prices that customers are willing to pay for each type of flight. John is interested in integrating some of this system's decisions with the ANS he owns. As the in-house system needs to get real-time data on the negotiating consumer, John asks the Computers Division manager, Jane Doe, to use the API and integrate the ANS and the in-house system. After this is done, the ANS approaches the in-house system with each reply it's about to give to a negotiating consumer, and the in-house system decides whether to leave the reply as is or to override it with the in-house system selected reply.

24. Simulated Negotiation

a. Lufthansa is quite happy with the new B2B contracts its newly acquired ANS is closing. However, very few consumers approached Lufthansa's web site for negotiation. After looking into this issue, it turned out that most consumers are afraid of using a system they're not familiar with, especially as they are obliged to identify themselves in order to negotiate. To encourage consumers to use this system, Lufthansa allows consumers to have three simulated negotiations, where they don't commit to buy anything. This should help consumers get used to how such negotiation looks before engaging in an obliging negotiation.

b. KLM is very attentive to what happens with their ANS. They keep watching through the monitor over what happens and many times, modify the existing rules or define new rules. As they are very cautious and are afraid of mistyping, which can cost much money, they always make changes that are initially deactivated. Only after they did some simulated negotiation sessions where they verified the effect of the modifications, only then, they commit to the changes they have made.

25. Limited Concurrent Negotiation

a. Sheraton is interested in offering good prices through negotiations, only when they can't get higher prices in other ways. They don't want users to try and negotiate in parallel with the system (maybe through an automated software that the consumer has), until a good price is achieved. Thus, they defined a rule to their ANS to allow each consumer to engage in only one negotiation concurrently. This will prevent consumers from negotiating in parallel for the same product and, agreeing to the best price achieved, while canceling all other negotiations. If consumers cancel a negotiation for a certain product, and then reattempt negotiation of the same product, they will probably be returned (it depends on the system definitions) to the exact point where they left the previous negotiation or they might be denied negotiation over that product or they may be charged a restart fee.

26. Limited Concurrent Negotiation-Products

a. Two ticket dealers for shows in Chicago are good friends. They want to prevent consumers from accessing the ANS of both dealers for negotiation of the same product concurrently. Thus, they define rules in both of the ANSs to check each negotiating consumer, at the beginning of the negotiation, and if that consumer is already negotiating for that product with the other dealer, to decline the attempt for concurrent negotiation of the product.

27. Cartoon Negotiators

a. John Doe is approaching the web site of Hertz in order to negotiate on a car for his next visit to Minneapolis. As he enters the negotiation page, he's presented with three cartoon images (A, B & C), barring the faces of agents he knows from the real agency, that he can choose from, to be the virtual negotiator on behalf of Hertz. As John has already been in both the site and the real car rental office for quite a few times, he knows that the cartoon C is more rewarding for returning consumers and that his best chances for getting a good price are by selecting that cartoon image as Hertz's negotiator. Hertz also reveals on their web site that cartoon image A is more lenient with consumers that travel with children, which is not the case for John this time.

28. Sell/buy Different Quantities Through Negotiation

a. Air-Jordan is interested in bundling 500 hotel rooms in Cairo with 500 of its flights. Their ANS approaches Hilton's ANS and gets an offer for $70 per night. As Air-Jordan's ANS is instructed to pay no more than $55 per room, negotiation starts, where Air-Jordan's ANS targets towards $55. Realizing that $55 is a bottom limit for Air-Jordan, Hilton's ANS decides to allow a price of $55 but in condition that Air-Jordan buys 700 rooms. Both ANSs agree and a deal is closed.

29. Up-Sell Through Negotiation

a. In London, Hertz's ANS looks for closing with British-Airways on car/flight bundles for travelers from NY or Toronto, to be offered on Hertz's web site. They ask BA's ANS for a price of $500 per flight ticket, traveling coach. BA's ANS refuses to a deal on coach tickets but suggests that Hertz acquire Business Class tickets instead, for $950 each. As Hertz travelers are prone to arrive in London repeatedly, possibly needing a car, they tuned their ANS accordingly and therefore, their ANS accepts the deal.

30. Cross-Sell Through Negotiation

a. SAS are interested in offering their customers, discounted theater tickets for shows in London, during February. Their ANS contacts the theater's ANS and asks for 40 tickets a day in February for $30 per ticket. The theater's ANS agrees with these terms, as long as SAS are willing to also purchase 50 tickets per day, for whole of May, for a new show the theater is showing.

31. Cartoon Negotiators-Toggled

a. John has been to United Airlines' web site negotiation many times. At first, he liked very much the wit text and funny images that are presented during the negotiation. However, as he had more and more negotiations carried through this site, he became familiar with this concept and got tired of it. Therefore, he asks the system to have only a simple text answers, approving his request, denying his request or offering a different thing. His wish is granted. At a later time, John can decide that he would like to see these images again, to get some amusement.

32. Short Messages Exchange

a. Jane is negotiating her next vacation with Delta Airlines' ANS. While negotiating, she's interested in claiming an upgrade to business class for the same price, as a compensation for the delayed Delta flight she took last week. As the ANS cannot automatically respond to such requests, she uses the SMS mechanism of the ANS to approach a human representative. She briefly describes what she's interested in and why. At the same time, Delta's representative—John, sits by a console and observes this message from Jane. John promises Jane to give her a reply in 5 minutes. He looks into the issue and then decides Jane's wish is granted. Jane receives a message from the ANS, based on John's intervention, that she's approved for upgrade to business class. She now continues the negotiation to discuss the other terms pertaining to the flight she's about to take.

The above system and its described functional elements are implemented in various computing environments. For example, the present invention may be implemented on a conventional IBM PC or equivalent, multi-nodal system (e.g., LAN) or networking system (e.g., Internet, WWW). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of computer programming.

1-47. (canceled)

48. A method of negotiating travel products via a network comprising:
receiving a travel product request from a node of the network associated with a consumer;
transmitting opening price terms for the travel product to the consumer node, the opening price terms expressed as a monetary value;
receiving over the network a rejection of the price terms;
when the rejection is received, then retrieving rules in a database, determining based on the rules whether the requested travel product may be provided to the consumer based on a combination of a monetary value and membership points, and, depending on the results of the determining step, transmitting confirmation to the node of the consumer that the requested travel product will be provided based on a specific monetary value and a specific number of membership points accepted by the consumer.

49. The method of claim 48 further comprising receiving a request from the consumer node to receive the travel product based on a combination of money and membership points.

50. The method of claim 48 further comprising receiving information from the consumer node specifying a monetary value and a number of membership points for the travel product.

51. The method of claim 50 further comprising transmitting information to the consumer node that specifies a different monetary value and number of membership points for the travel product after the information is received from the consumer.

52. The method of claim 48 comprising modifying the opening price terms depending on information relating to the consumer.

53. The method of claim 52 wherein the information relating to the consumer comprises an indication of whether the consumer has membership points.

54. The method of claim 52 wherein the consumer-related information comprises the consumer's prior negotiation history.

55. The method of claim 48 further comprising, before the step of receiving a travel product request from a node of the network associated with a consumer, the steps of:
receiving a travel product request;
finding travel products matching the travel product request.

56. The method of claim 48 wherein the travel product comprises a reservation for one or more of the following: airline, hotel or car rental.

57. The method of claim 48 wherein the travel product is provided based on a specific monetary value, a specific number of membership points, and one or more of the following: type of payment; delivery time; quantity; upgrades; cross-sales; and time of reservation.

58. The method of claim 48 further comprising modifying the travel product to include an upgrade to the travel product.

59. A system for negotiating the provision of a travel product over a network of nodes comprising:
a provider node associated with the provider of a travel product;
a database accessible by the provider node, the database comprising rules defining acceptable combinations of award points and monetary values for which the product will be provided; and
a requester node associated with an entity requesting the travel product, such that requester is a member of program providing award points associated with the travel product;
wherein the provider node or requester node are configured to receive offers to provide the travel product based on combinations of monetary value and award points.

60. A system of selling travel products over a network comprising:
a first computer in electronic communication with a second computer,
a database comprising rules for determining whether a travel product may be sold based on a combination of award points and a dollar-based price;
the first computer including software, the software comprising instructions including: transmitting identification of a travel product to the second computer; accessing the database and determining, based on the rules, whether the travel product may be sold based on a combination of award points and a dollar-based price; dependant on the step of determining, transmitting an indication to the second computer that the travel product will be sold based on the second computer's acknowledgement of acceptance of a non-zero price and non-zero award points possessed by the user associated with the second computer.

61. A method of obtaining a travel product comprising:
receiving information at a first computer from a second computer, the information identifying a travel product associated with a monetary price,
transmitting a request from the first computer to the second computer to reduce the price of the travel product in exchange for conveying membership points, and
receiving confirmation from the second computer that the travel product will be provided at a reduced non-zero price in exchange for membership points.

62. A method of negotiating the purchase of a travel product between an entity associated with a first computer and an entity associated with a second computer in electronic communication with the first computer comprising:
the first computer transmitting first information to the second computer, the first information approving the sale of the travel-related product depending upon the second computer's acceptance of one or more values, the values falling within one or more travel-product categories, any category represented by a value identified by the first information being hereafter referred to as a First Proposed Category;
one of said computers transmitting second information to the other said computer, the second information indicating acceptance of the sale of the travel-related product based on acceptance of two or more values, such that one value falls within a First Proposed Category and the other value does not fall within a First Proposed Category;
one of said computers accessing a database of rules, without human intervention, to determine whether values identified by the second information would be acceptable to the entity providing the travel-related product; and
the first and second computer providing an indication to the other that the sale of the travel-related product is acceptable based on the values identified by the second information;
wherein the travel-related categories comprise the following categories of the travel-related product: monetary price, number of non-monetary points to be redeemed to obtain the travel-related product, payment method, time, quantity, size, and additional articles to be provided with the travel-related product.

63. The method of claim 62 wherein the second information is generated during the step of accessing the database of rules.

64. The method of claim 62 wherein one of the First Proposed Categories is the monetary-price of the travel-related product.

65. The method of claim 62 wherein the travel-related product comprises at least an airline flight and the travel-related categories further comprise: seat class, aisle/window, row, number of award points to be awarded for flight, and business lounge entry.

66. The method of claim 62 wherein the travel-related product comprises at least a hotel room and the travel-related categories further comprise: bed type, view from room, meals to be provided, in-room amenities, club-room access, and floor.

67. The method of claim 62 wherein the travel-related product comprises at least a car rental and the travel-related categories further comprise: car class, whether the car is a convertible, 4-wheel drive, unlimited mileage, and sunroof.

68. The method of claim 62 wherein the travel-related product comprises at least a theatre-ticket and the travel-related categories further comprise: row, seat location within row, binoculars, 3D glasses, whether time is associated with a weekday, bonus shows and show program.

69. The method of claim 62 wherein the first computer is associated with the provider of the travel-related product and the step of accessing the database comprises the first computer accessing the database.

70. The method of claim 62 wherein the second computer is associated with the provider of the travel-related product and the step of accessing the database comprises the second computer accessing the database.

71. The method of claim 62 wherein monetary price is a First Proposed Category and non-monetary points are not a First Proposed Category.

72. The method of claim 71 wherein the value of the monetary price identified in the second information is less than the value of the monetary price identified in the first information.

73. The method of claim 62 wherein monetary price is not a First Proposed Category and non-monetary points are a First Proposed Category.
